(19) United States
(12) Patent Application Publication
(10) Pub. No.: US 2024/0239371 A1
(43) Pub. Date: Jul. 18, 2024

(54) NAVIGATION DEVICE, NAVIGATION METHOD, AND STORAGE MEDIUM

(71) Applicant: TOYOTA JIDOSHA KABUSHIKI KAISHA, Toyota-shi (JP)

(72) Inventor: Naoki IHARA, Susono-shi (JP)

(73) Assignee: TOYOTA JIDOSHA KABUSHIKI KAISHA, Toyota-shi (JP)

(21) Appl. No.: 18/475,551

(22) Filed: Sep. 27, 2023

(30) Foreign Application Priority Data
Jan. 18, 2023 (JP) 2023-006181

(51) Int. Cl. B60W 60/00; G01C 21/34

(52) U.S. Cl. CPC B60W 60/001; G01C 21/3407; B60W 2554/00

(57) ABSTRACT

In the embodiment of the present disclosure, first, the navigation device acquires the destination set by the user. Next, the navigation device acquires information about available parking spaces accessible from the roads for each road near the destination. Then, the navigation device selects a road with a predetermined number or more of accessible vacant parking spaces as a guidance destination for the vehicle.

### CROSS-REFERENCE TO RELATED APPLICATION

This application claims priority to Japanese Patent Application No. 2023-006181 filed on Jan. 18, 2023, incorporated herein by reference in its entirety.

### BACKGROUND

### 1. Technical Field

The present disclosure relates to a navigation technology including a navigation device, a navigation method, and a storage medium, and particularly to a navigation technology that can be used for autonomous driving vehicles.

### 2. Description of Related Art

As a related art for the navigation technology of the present disclosure, there is a parking lot information guidance device disclosed in Japanese Unexamined Patent Application Publication No. 2020-122722 (JP 2020-122722 A). In this related art, when the parking lot attached to the destination is full, the destination is changed to a first parking area. If the parking lot in the first parking area is full, the destination is further changed to a second parking area.

### SUMMARY

The above related art merely notifies vacant parking lots in order. If one parking lot is full and you have to move to another vacant parking lot, there is no guarantee that they face the same road and it may take time to move between parking lots. As a result, when the vehicle reaches the destination parking lot, it may happen that the parking lot is also full.

The present disclosure has been made in view of the above problems. An object of the present disclosure is to provide a technology capable of increasing the probability that a vehicle can be parked near a destination.

To achieve the above object, the present disclosure provides a navigation device. The navigation device of the present disclosure includes: at least one processor; and at least one memory that stores a plurality of instructions executable by the at least one processor.
The instructions are configured to cause the at least one processor to execute the following processes.
A first process is to acquire a set destination.
A second process is to acquire, for each road near the destination, information about a vacant parking space accessible from the road.
A third process is to select a road with a predetermined number or more of the accessible vacant parking space as a guidance destination to which a vehicle is guided.

Moreover, in order to achieve the above object, the present disclosure provides a navigation method used by a navigation device. The navigation method of the present disclosure includes the following steps.
A first step is to acquire a set destination.
A second step is to acquire, for each road near the destination, information about a vacant parking space accessible from the road.
A third step is to select a road with a predetermined number or more of the accessible vacant parking space as a guidance destination to which a vehicle is guided.

Furthermore, in order to achieve the above object, the present disclosure provides a storage medium storing a navigation program. The navigation program of the present disclosure is configured to cause a navigation device to execute the above navigation method. The navigation program of the present disclosure may be stored in a non-transitory computer-readable storage medium.

In the navigation technology of the present disclosure, a road may be excluded when a time required to arrive the road is longer than a predetermined allowable time. Moreover, a road closest to the destination among roads with a predetermined number or more of accessible vacant parking spaces may be selected as the guidance destination.

According to the navigation technology of the present disclosure, among roads near the destination, roads with a predetermined number or more of accessible vacant parking spaces are selected as the guidance destination, so that the probability that the vehicle can be parked near the destination is increased.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing the configuration of a navigation device according to the first embodiment of the present disclosure;

FIG. 2 is a flowchart illustrating a navigation method according to the first embodiment of the present disclosure;

FIG. 3 is a diagram explaining a specific example of using the navigation method shown in FIG. 2 to search for a parking lot in an urban area;

FIG. 4 is a diagram illustrating a specific example of using the navigation method shown in FIG. 2 to search for a parking space in a parking lot;

FIG. 5 is a block diagram showing the configuration of an autonomous driving vehicle equipped with a navigation device according to the second embodiment of the present disclosure; and

FIG. 6 is a flowchart illustrating a navigation method according to a second embodiment of the disclosure.

### DETAILED DESCRIPTION OF EMBODIMENTS

### 1. First Embodiment

### 1-1. Navigation Device

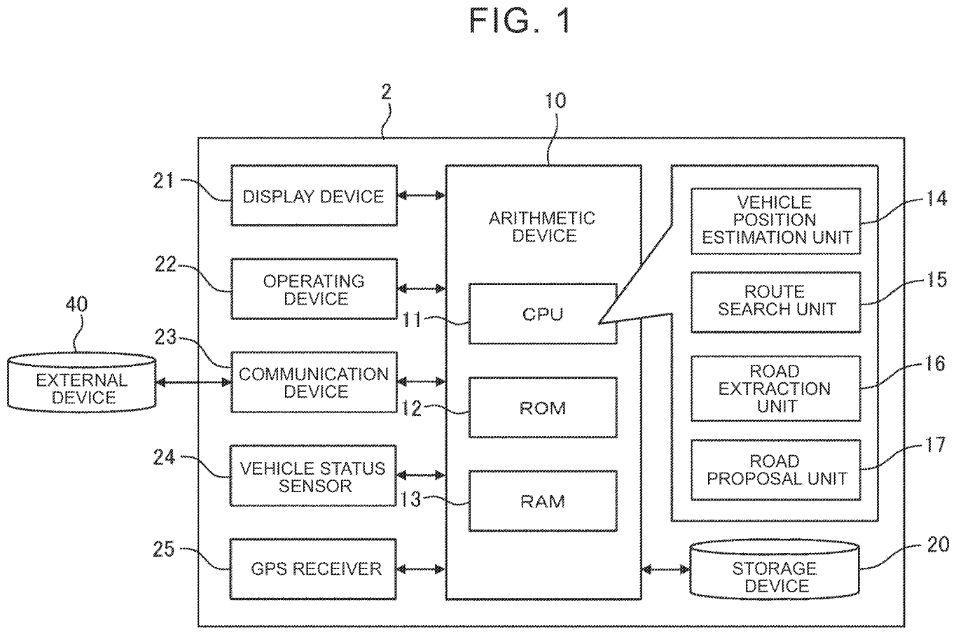

A navigation device according to the first embodiment is mounted in a vehicle that is manually operated by a driver. When a user sets a destination, the navigation device according to the first embodiment does not propose a route to the destination to the user, but searches for a parking slot for parking the vehicle from roads near the destination. It is configured to select the optimum road above and propose guidance to that road to the user. The configuration of the navigation device according to the first embodiment will be described below with reference to FIG. 1.

FIG. 1 is a block diagram showing the configuration of a navigation device 2 according to the first embodiment. The navigation device 2 includes an arithmetic device 10, a storage device 20, a display device 21, an operation device 22, a communication device 23, a vehicle state sensor 24 and a GPS receiver 25. A storage device 20, a display device 21, an operation device 22, a communication device 23, a vehicle state sensor 24, and a GPS receiver 25 are communicably connected to the arithmetic device 10.

The storage device 20 is a storage that stores data necessary for navigation. The stored data includes high definition map data. The stored data also includes user-defined destinations and user-defined road selection parameters. The navigation device 2 selects a road to be proposed to the user as a guidance destination from among a plurality of roads near the destination. A road selection parameter is a parameter used in the process for the selection. The storage device 20 stores the following three parameters as road selection parameters.

### Parameter 1: Road Division Distance

(Explanation) A long road is divided (divided into two, three, etc.) until it becomes shorter than the division distance.

### Parameter 2: Allowable Time Difference in Required Time

(Explanation) Exclude from candidate roads farther than the road with the shortest required time from the vehicle position and the difference in required times exceeding the allowable time.

### Parameter 3: Setting the Distance to the Destination

(Explanation) The distance to the destination of the road used to select the proposed road can be set to either the distance from the center of the road or the distance from the center of gravity of the position of the empty parking space.

A display device 21 and an operation device 22 are the HMI of the navigation device 2. The display device 21 can display a map and various information such as the vehicle position, the destination, the route to the destination, the proposed road, and the route to the guidance road on the map. Further, the operation device 22 receives input from the user. Inputs from the user include, for example, setting a destination, setting road selection parameters, and selecting a guidance destination from among a plurality of suggested roads.

The communication device 23 is a device that controls communication between the navigation device 2 and the external device 40. The communication device 23 communicates with the external device 40 via a communication network. The external device 40 is, for example, a cloud server. The external device 40 collects information on vacant parking slots in parking lots registered in advance in the service in real time or at regular time intervals. The navigation device 2 uses the communication device 23 from the external device 40 to acquire information about empty parking spaces for each parking lot. Information about the acquired empty parking space is stored in the storage device 20.

Vehicle state sensor 24 includes a vehicle speed sensor, an acceleration sensor, and a gyro sensor. The information obtained by these sensors is used together with the information obtained by the GPS receiver 25 to calculate the position, attitude and direction of movement of the vehicle on the map.

The arithmetic device 10 is the main body of the navigation device 2. Arithmetic device 10 includes a processor and a memory. The processor includes CPU 11 and the memory includes ROM 12 and RAM 13. ROM 12 and RAM 13 are communicatively coupled to CPU 11. Each number of the CPU 11, the ROM 12, and the RAM 13 constituting the arithmetic device 10 maybe singular or plural. ROM 12 stores at least one program executable by CPU 11. Programs stored in ROM 12 include navigation programs. The ROM 12 is an example of a storage medium. A navigation program consists of multiple instructions. The CPU 11 functions as a vehicle position estimation unit 14, a route search unit 15, a road extraction unit 16, and a road proposal unit 17 by executing these instructions in the CPU 11. The function of each part will be described below.

The vehicle position estimation unit 14 estimates the position of the own vehicle on the map based on each information acquired by the vehicle state sensor 24 and the GPS receiver 25. Specifically, the information from the GPS receiver 25 is used to estimate the coordinates of the vehicle on the map. Information from the gyro sensor is used to estimate the attitude of the vehicle on the map. Then, the amount of movement of the own vehicle on the map is estimated from each information from the vehicle speed sensor and the acceleration sensor.

A route search unit 15 searches for a route from the current position of the vehicle to a specified location. The searched route is displayed on the display device 21 as required. The specified location includes a location specified by the user and a location specified by the CPU 11 itself. The location specified by the user includes the destination set by the user and the road selected by the user as a guidance destination. The location specified by the CPU 11 itself will be explained in the explanation of the road extraction unit 16.

A road extraction unit 16 sequentially extracts roads close to the destination from the map information. If the destination is a facility that has an entrance, the road extraction unit 16 extracts the road based on the entrance. At that time, roads longer than the division distance set by Parameter 1 are divided into a plurality of roads, and each divided road is extracted as a separate road. The road extraction unit 16 also uses the route search unit 15 to calculate the required time from the current position of the vehicle to each road. Then, the road extraction unit 16 excludes roads with required travel times exceeding the allowable time difference from the extraction targets, based on the road with the shortest required travel time.

The road proposal unit 17 acquires the position of the parking space and the parking space availability information recorded in the external device 40 via the communication device 23. Then, the road proposal unit 17 counts the number of accessible vacant parking spaces for each road extracted by the road extraction unit 16 based on the acquired information. The vacant parking spaces to be aggregated include not only vacant parking spaces in parking lots directly facing the road, but also vacant parking spaces in all parking lots accessible from the road.

Next, the road proposal unit 17 proposes a road close to the destination (a road close to the entrance of the facility at the destination) from roads on which a predetermined number or more of accessible parking spaces exist. The above predetermined number, that is, the number of vacant parking spaces that serves as a reference for making a proposal may be a fixed value, or may be a parameter that can be set by the user. The roads closer to the proposed destination are selected according to the setting of Parameter 3, distance to destination. The road proposal unit 17 displays the proposed road on the display device 21. When the user selects the road using the operation device 22, the route search unit 15 starts route guidance with the road as the guidance destination.

### 1-2. Navigation Method

### 1-2-1. Overview

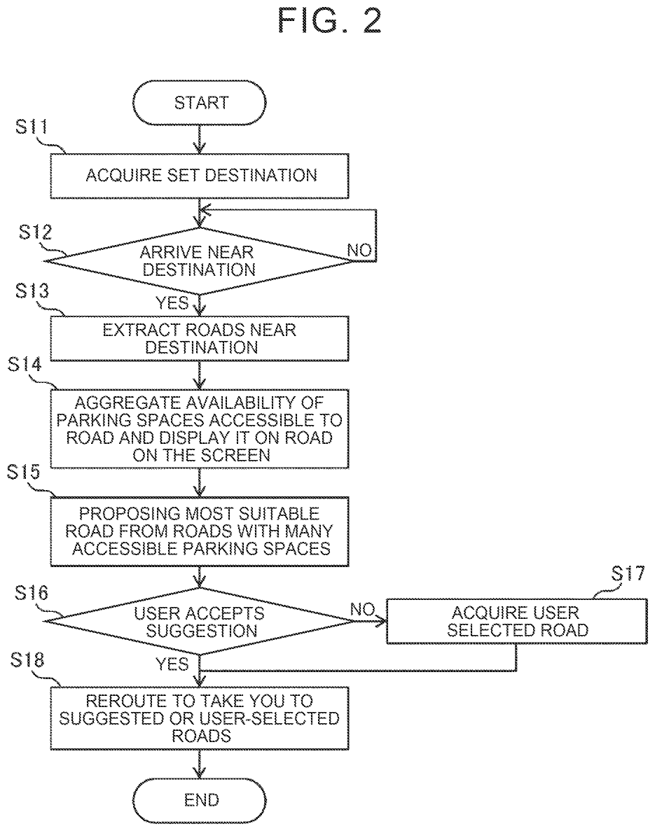

FIG. 2 is a flowchart showing a navigation method (navigation method according to this embodiment) executed by the navigation device 2 described above. The navigation method according to this embodiment includes eight steps from S11 to S18. The outline of each step is as follows.
S11: Acquisition of destination set by user
S12: Determining whether the vehicle has arrived near the destination
S13: Extract the roads near the destination in response to the arrival of the vehicle in the vicinity of the destination
S14: Aggregate the availability of parking spaces accessible from the road, and superimpose the aggregated results on the road displayed on the screen of the display device 21.
S15: Propose to the user the most suitable road among roads with many accessible parking spaces.
S16: Determining whether the user has accepted the proposal
S17: Obtain the road selected by the user in response to the user's rejection of the proposal
S18: Change the route to guide the vehicle to the proposed road or the road selected by the user

### 1-2-2. Example 1

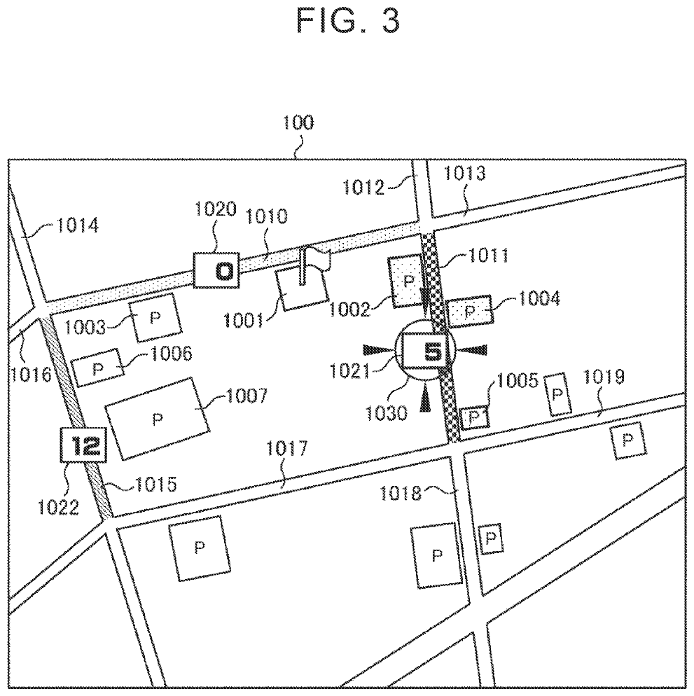

Next, details of each step of the navigation method according to the present embodiment will be specifically described with reference to FIG. 3. FIG. 3 is a diagram for explaining a specific example in which the navigation method according to this embodiment is used to search for a parking lot in an urban area.

### S11

The user selects a destination 1001 using the operation device 22 on the map 100 displayed on the display device 21 and sets the destination 1001 on the arithmetic device 10. The arithmetic device 10 acquires the destination 1001 set by the user and stores it in the storage device 20.

### S12

The arithmetic device 10 compares the position of the vehicle estimated by the vehicle position estimation unit 14 with the destination 1001 and determines whether the vehicle has arrived at a predetermined distance from the destination 1001. The predetermined distance, which is used as a criterion for determining whether the destination 1001 is near, may be a fixed value such as 500 m or 1 km, or may be arbitrarily set by the user.

### S13

The road extraction unit 16 of the arithmetic device 10 first refers to the high-definition map data stored in the storage device 20 and extracts a road 1010 facing the destination 1001 from roads around the destination 1001. The road extraction unit 16 then extracts roads 1011 to 1016 that are directly connected to the road 1010. The road extraction unit 16 repeats this extraction a predetermined number of times. In the case of roads with separate inbound and outbound lines, roads that are connected on each of the inbound and outbound lines are extracted. As a method of extracting roads near the destination 1001, there is also a method of extracting roads within a predetermined radius from the destination 1001.

Further, the road extraction unit 16 selects roads to be extracted according to Parameter 2 of the road selection parameters. In other words, the road extraction unit 16 excludes, from the objects to be extracted, roads whose required time difference exceeds the allowable time difference with respect to the road with the shortest required time from the current position of the vehicle. In the example shown in FIG. 3, the roads 1017 to 1019 are far from the current position of the own vehicle (not shown), so they are excluded from extraction targets even though there is a parking lot facing the road.

### S14

Arithmetic device 10 first totalizes the availability of parking lots 1003 accessible from road 1010 and displays the number of vacant parking spaces on counter 1020 superimposed on road 1010. The arithmetic device 10 then calculates the total number of vacant parking spaces for parking lots 1002, 1004, and 1005 accessible from the road 1011, and displays the total number of vacant parking spaces on a counter 1021 superimposed on the road 1011. Parking lots 1006 and 1007 are accessible from road 1015. Arithmetic device 10 calculates the total number of vacant parking spaces in parking lots 1006 and 1007 and displays the total number of vacant parking spaces on counter 1022 superimposed on road 1015. On the other hand, roads 1012, 1013, 1014 and 1016 do not have parking lots accessible from those roads. Therefore, nothing is displayed on the roads 1012, 1013, 1014, 1016.

In addition to displaying the number of vacant parking spaces, the road may be colored according to the number of vacant parking spaces. For example, a road 1010 with zero empty parking spaces may be colored red, a road 1015 with many empty parking spaces may be colored blue, and a road 1011 with few empty parking spaces may be colored yellow. Also, the roads 1012, 1013, 1014, 1016 that do not face the parking lot may be colored black.

### S15

The road proposal unit 17 of the arithmetic device 10 proposes to the user a road that is closer to the destination 1001 from roads having a predetermined number or more of accessible parking spaces. The calculation of the distance at the time of proposal is performed according to the setting of Parameter 3 of the road selection parameters. In the example shown in FIG. 3, roads 1011 and 1015 are the only roads on which the number of accessible vacant parking spaces is greater than or equal to a predetermined number. Of these, the road with the shortest distance from the destination 1001 is the road 1011, so the road proposal unit 17 proposes the road 1011 to the user. The suggestions are made, for example, by moving the cursor 1030 to the counter 1021 and highlighting the road 1011 and parking lots 1002, 1004, 1005.

Note that in this example, roads that take longer than the allowable travel time from the host vehicle are excluded from the extraction targets. However, all roads close to the destination including those roads may be extracted, and the priority of the proposal may be lowered according to the time required from the current location. For example, roads 1017 to 1019 are given lower priority for suggestions than roads 1011 and 1015, even though there are many empty parking slots.

### S16

If the proposed road 1011 is acceptable, the user uses the operation device 22 to select the road 1011 as a guidance destination. Arithmetic device 10 receives a selection result by the user from operation device 22.

### S17

If the user desires a road other than the proposed road 1011, the user can use the operation device 22 to select a road other than the road 1011. In the example shown in FIG. 3, the user moves the cursor 1030 on the map 100, aligns the cursor 1030 with the counter 1022, and presses a selection button (not shown). As a result, the road 1015 is selected as the guidance destination for guiding the vehicle.

### S18

When the user's proposal is accepted, the route search unit 15 of the arithmetic device 10 changes the route so as to guide the vehicle to the proposed road 1011. If the user does not accept the proposal, the route search unit 15 changes the route so as to guide the vehicle to the road 1015 selected by the user.

### 1-2-3. Example 2

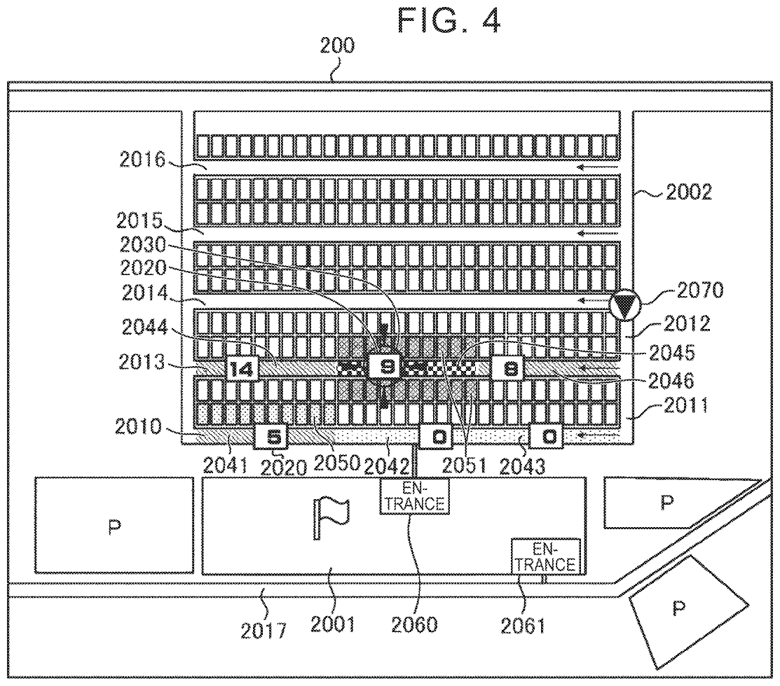

Details of each step of the navigation method according to the present embodiment will be further specifically described with reference to FIG. 4. FIG. 4 is a diagram for explaining a specific example of using the navigation method according to the present embodiment to search for a parking space in a parking lot. In the parking lot, a plurality of parking spaces directly face the road. As will be described below, the navigation method according to this embodiment is effective even in such places. Since the contents of S11 to S12 and S16 to S18 are the same as those of the specific example 1, the description thereof is omitted.

### S13

The road extraction unit 16 of the arithmetic device 10 first extracts the road 2010 in the parking lot 2002 facing the entrance 2060 of the destination 2001. Since the road 2010 is longer than the division distance set by Parameter 1 of the road selection parameters, the road extraction unit 16 divides the road 2010 into roads 2041 to 2043 shorter than the division distance. Next, the road extraction unit 16 extracts the road 2011 directly connected to the road 2010, and further extracts the roads 2012 and 2013 directly connected to the road 2011. Since the road 2013 is longer than the division distance, the road extraction unit 16 divides the road 2013 into roads 2044 to 2046 shorter than the division distance.

Destination 2001 has entrance 2061 in addition to entrance 2060. The road 2017 faces the entrance 2061 and there are a plurality of parking lots facing the road 2017 near the entrance 2061. However, the road 2017 takes an extremely long time from the current position 2070 of the vehicle compared to the road in the parking lot 2002. Therefore, the road extraction unit 16 excludes the road 2017 from the extraction targets according to Parameter 2 of the road selection parameters. Also, since the parking lot 2002 is a one-way street, the roads 2014 to 2016 cannot be reached from the current position 2070. Therefore, the road extraction unit 16 excludes the roads 2014-2016 from the extraction target.

### S14

Arithmetic device 10 first totalizes the availability of parking spaces 2050 facing the divided road 2041 and displays the number of available parking spaces on counter 2020 superimposed on road 2041. Similarly, the arithmetic device 10 calculates the total number of vacant parking spaces for the other extracted roads 2042-2046, and displays the total number of vacant parking spaces on a counter superimposed on the road. Further, the arithmetic device 10 not only displays the number of vacant parking spaces, but also colors the road according to the number of vacant parking spaces.

### S15

The road proposal unit 17 of the arithmetic device 10 proposes to the user a road closest to the entrance 2060 of the destination 1001 from among the roads facing the road having a predetermined number or more of vacant parking spaces. Here, it is assumed that the reference number of vacant parking spaces is seven. In the example shown in FIG. 4, roads 2044, 2045, and 2046 have seven or more empty parking spaces. Since the road 2045 is the shortest road from the entrance 2060, the road proposal unit 17 proposes the road 2045 to the user. The suggestion is made, for example, by moving cursor 2030 to counter 2020 on road 2045 and highlighting road 2045 and parking bay 2051 facing road 2045.

### 2. Second Embodiment

### 2-1. Navigation Device

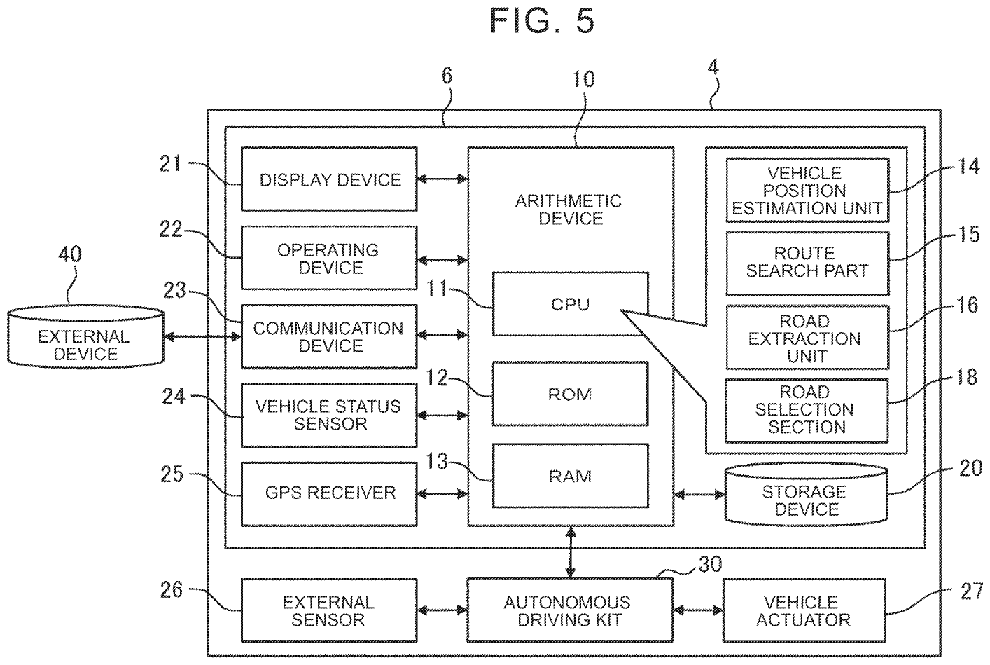

A navigation device according to the second embodiment is installed in an autonomous driving vehicle. When the user sets the destination, the navigation device according to the second embodiment selects the most suitable road for searching for a parking slot for parking the vehicle from the roads near the destination, and autonomously directs the vehicle to that road. It is configured to request travel to the autonomous driving kit. The configuration of an autonomous driving vehicle equipped with a navigation device according to the second embodiment will be described below with reference to FIG. 5.

FIG. 5 is a block diagram showing the configuration of an autonomous driving vehicle 4 equipped with a navigation device 6 according to the second embodiment. The autonomous driving vehicle 4 includes a navigation device 6, an external sensor 26, an autonomous driving kit 30 and vehicle actuators 27. Navigation device 6, external sensors 26, and vehicle actuator 27 are communicatively connected to autonomous driving kit 30.

The external sensor 26 is a sensor that acquires surrounding information of the vehicle. External sensors 26 include at least one of a camera, millimeter wave radar, and LiDAR. Based on the surrounding information obtained by the external sensor 26, the autonomous driving kit 30 detects objects existing around the vehicle, measures the relative position and relative speed of the detected object with respect to the vehicle, and recognizes the shape of the detected object. Then, the autonomous driving kit 30 generates a target trajectory based on the travel route of the vehicle and the recognition result of the object input from the navigation device 6, and controls the vehicle actuator 27 so that the vehicle travels along the target trajectory. Calculate quantity. The vehicle actuator 27 includes drive actuators that drive the vehicle, brake actuators that brake the vehicle, and steering actuators that steer the vehicle.

The physical configuration of the navigation device 6 is the same as that of the navigation device 2 according to the first embodiment. The difference between the navigation device 6 and the navigation device 2 according to the first embodiment lies in the navigation program stored in the ROM 12. In the navigation device 6, the CPU 11 executes instructions constituting a navigation program, and the CPU 11 functions as a vehicle position estimation unit 14, a route search unit 15, a road extraction unit 16, and a road selection unit 18. The functions of the vehicle position estimation unit 14, the route search unit 15, and the road extraction unit 16 are the same as those of the first embodiment.

The road selection unit 18 acquires the position of the parking space and the parking space availability information recorded in the external device 40 via the communication device 23. Next, the road selection unit 18 aggregates the number of accessible parking slots for each road extracted by the road extraction unit 16 based on the acquired information. Then, the road selection unit 18 selects the road closest to the destination (the road closest to the entrance of the facility at the destination) from the roads on which a predetermined number or more of accessible parking spaces exist. When the road selection unit 18 selects a road, the route search unit 15 searches for a travel route of the vehicle to that road. The travel route searched by the route search unit 15 is input to the autonomous driving kit 30.

### 2-2. Navigation Method

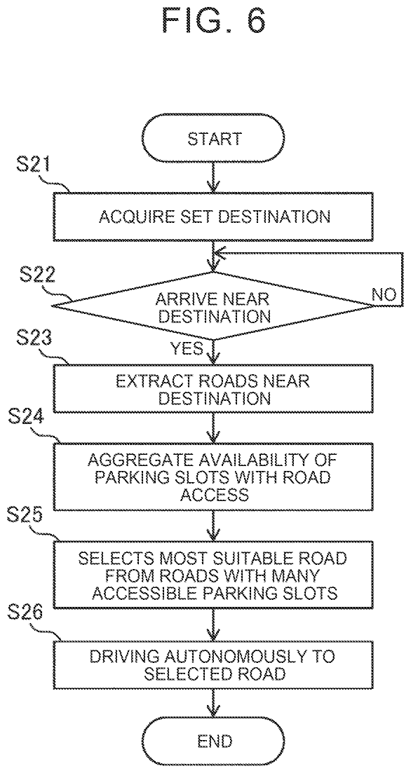

FIG. 6 is a flowchart showing a navigation method (navigation method according to this embodiment) executed by the navigation device 6 described above. The navigation method according to this embodiment includes six steps from S21 to S26.

S21 to S23 correspond to S11 to S13 of the navigation method according to the first embodiment. In S21, the navigation device 6 acquires the destination set by the user and stores it in the storage device 20. In S22, the navigation device 6 compares the estimated position of the vehicle with the destination, and determines whether the vehicle has arrived around the destination. Then, in S23, the navigation device 6 refers to the high-precision map data stored in the storage device 20 and extracts roads near the destination. When extracting roads, roads to be extracted are selected according to Parameter 2 of the road selection parameters.

In S24, the navigation device 6 aggregates the availability of parking spaces accessible from the road for each road extracted in S23. In S25, the optimum road is selected from the roads on which there are many accessible vacant parking spaces, based on the tallied result in S24. Typically, the road closest to the destination is selected. Then, in S26, the navigation device 6 transmits the travel route to the selected road to the autonomous driving kit 30 so that the vehicle autonomously travels toward the selected road.

### 3. Others

The navigation technology of the present disclosure can also be applied to a remote driving system that remotely drives a vehicle using wireless communication from a remote cockpit. In that case, the navigation device may be installed in the remote cockpit and acquire sensor information from the vehicle through wireless communication.

What is claimed is:

1. A navigation device comprising:
at least one processor; and
at least one memory that stores a plurality of instructions executable by the at least one processor, wherein the instructions are configured to cause the at least one processor to execute
acquiring a set destination,
acquiring, for each road near the destination, information about a vacant parking space accessible from the road, and
selecting a road with a predetermined number or more of the accessible vacant parking space as a guidance destination to which a vehicle is guided.

2. The navigation device according to claim 1, wherein the instructions are configured to cause the at least one processor to execute excluding, from the guidance destination, a road when a time required to arrive the road is longer than a predetermined allowable time.

3. The navigation device according to claim 1, wherein the instructions are configured to cause the at least one processor to execute selecting, as the guidance destination, a road closest to the destination among the roads with the predetermined number or more of the accessible vacant parking space.

4. A navigation method used by a navigation device, the navigation method comprising:
acquiring a set destination;
acquiring, for each road near the destination, information about a vacant parking space accessible from the road; and
selecting a road with a predetermined number or more of the accessible vacant parking space as a guidance destination to which a vehicle is guided.

5. A non-transitory storage medium storing a navigation program configured to cause a navigation device to execute
acquiring a set destination,
acquiring, for each road near the destination, information about a vacant parking space accessible from the road, and
selecting a road with a predetermined number or more of the accessible vacant parking space as a guidance destination to which a vehicle is guided.
